(19) United States
(12) Patent Application Publication
(10) Pub. No.: US 2002/0188941 A1
(43) Pub. Date: Dec. 12, 2002

(54) Efficient installation of software packages

(75) Inventors: Ulises J. Cicciarelli, Miami, FL (US); Daniel R. Drake, Apex, NC (US); James E. Fox, Apex, NC (US); Robert C. Leah, Cary, NC (US)

Correspondence Address: IBM Corporation, T81/062, PO Box 12195, Research Triangle Park, NC, 27709, US

(73) Assignee: International Business Machines Corporation, Armonk, NY

(21) Appl. No.: 09/879,694

(22) Filed: Jun. 12, 2001

(51) Int. Cl. G06F 9/445

(52) U.S. Cl. 717/175; 717/174; 717/116

(57) ABSTRACT

Methods, systems, and computer program products for improving installation of software packages using an incremental conditional installation process (and optionally, caching of installation components). An object model is disclosed which enables specification of the conditional installation information as one or more elements of the model (and therefore of an object, document, etc., which is created according to the model). Conditional installation information may be defined at a suite level and/or at a component level. The identified checking process then executes to determine whether the corresponding suite or component should be installed. One or more components may be cached, if desired. Resource utilization is improved using the conditional installation and optional caching techniques, enabling reductions in disk space usage, CPU consumption, and/or networking bandwidth consumption.

### RELATED INVENTIONS

The present invention is related to U.S. Pat. No. ______ (Ser. No. 09/669,227, filed Sep. 25, 2000), titled “Object Model and Framework for Installation of Software Packages Using JavaBean™”; U.S. Pat. No. ______ (Ser. No. 09/707,656, filed Nov. 7, 2000), titled “Object Model and Framework for Installation of Software Packages Using Object Descriptors”; U.S. Pat. No. ______ (Ser. No. 09/707,545, filed Nov. 7, 2000), titled “Object Model and Framework for Installation of Software Packages Using Object REXX”, and U.S. Pat. No. ______ (Ser. No. 09/707,700, filed Nov. 7, 2000), titled “Object Model and Framework for Installation of Software Packages Using Structured Documents”. These inventions, referred to hereinafter as “the related inventions”, are commonly assigned to the International Business Machines Corporation (IBM) and are hereby incorporated herein by reference.

### BACKGROUND OF THE INVENTION

1. Field of the Invention

The present invention relates to a computer system, and deals more particularly with methods, systems, and computer program products for improving the installation of software application packages by using an incremental conditional installation process (and, optionally, caching of selected install components).

2. Description of the Related Art

Use of computers in today's society has become pervasive. The software applications to be deployed, and the computing environments in which they will operate, range from very simple to extremely large and complex. The computer skills base of those responsible for installing the software applications ranges from novice or first-time users, who may simply want to install a game or similar application on a personal computer, to experienced, highly-skilled system administrators with responsibility for large, complex computing environments. The process of creating a software installation package that is properly adapted to the skills of the eventual installer, as well as to the target hardware and software computing environment, and also the process of performing the installation, can therefore be problematic.

In recent decades, when the range of computing environments and the range of user skills was more constant, it was easier to target information on how software should be installed. Typically, installation manuals were written and distributed with the software. These manuals provided textual information on how to perform the installation of a particular software application. These manuals often had many pages of technical information, and were therefore difficult to use by those not having considerable technical skills. “User-friendliness” was often overlooked, with the description of the installation procedures focused solely on the technical information needed by the software and system.

With the increasing popularity of personal computers came a trend toward easier, more user-friendly software installation, as software vendors recognized that it was no longer reasonable to assume that a person with a high degree of technical skill would be performing every installation process. However, a number of problem areas remained because of the lack of a standard, consistent approach to software installation across product and vendor boundaries. These problems, which are addressed in the related inventions, will now be described.

The manner in which software packages are installed today, and the formats of the installation images, often varies widely depending on the target platform (i.e. the target hardware, operating system, etc.), the installation tool in use, and the underlying programming language of the software to be installed, as well as the natural language in which instructions are provided and in which input is expected. When differences of these types exist, the installation process often becomes more difficult, leading to confusion and frustration for users. For complex software packages to be installed in large computing systems, these problems are exacerbated. In addition, developing software installation packages that attempt to meet the needs of many varied target environments (and the skills of many different installers) requires a substantial amount of time and effort.

One area where consistency in the software installation process is advantageous is in knowing how to invoke the installation procedure. Advances in this area have been made in recent years, such that today, many software packages use some sort of automated, self-installing procedure. For example, a file (which, by convention, is typically named “setup.exe” or “install.exe”) is often provided on an installation medium (such as a diskette or CD-ROM). When the installer issues a command to execute this file, an installation program begins. Issuance of the command may even be automated in some cases, whereby simply inserting the installation medium into a mechanism such as a CD-ROM reader automatically launches the installation program.

These automated techniques are quite beneficial in enabling the installer to get started with an installation. However, there are a number of other factors which may result in a complex installation process, especially for large-scale applications that are to be deployed in enterprise computing environments. For example, there may be a number of parameters that require input during installation of a particular software package. Arriving at the proper values to use for these parameters may be quite complicated, and the parameters may even vary from one target machine to another. There may also be a number of prerequisites and/or co-requisites, including both software and hardware specifications, that must be accounted for in the installation process. There may also be issues of version control to be addressed when software is being upgraded. An entire suite or package of software applications may be designed for simultaneous installation, leading to even more complications. In addition, installation procedures may vary widely from one installation experience to another, and the procedure used for complex enterprise software application packages may be quite different from those used for consumer-oriented applications.

Furthermore, these factors also affect the installation package developers, who must create installation packages which properly account for all of these variables. Today, installation packages are typically created using vendor-specific and product-specific installation software. Adding to or modifying an installation packages can be quite complicated, as it requires determining which areas of the installation source code must be changed, correctly making the appropriate changes, and then recompiling and retesting the installation code. End-users may be prevented from adding or modifying the installation packages in some cases, limiting the adaptability of the installation process. The lack of a standard, robust product installation interface therefore results in a labor-intensive and error-prone installation package development procedure.

Other practitioners in the art have recognized the need for improved software installation techniques. In one approach, generalized object descriptors have been adapted for this purpose. An example is the Common Information Model (CIM) standard promulgated by The Open Group™ and the Desktop Management Task Force (DTMF). The CIM standard uses object descriptors to define system resources for purposes of managing systems and networks according to an object-oriented paradigm. However, the object descriptors which are provided in this standard are very limited, and do not suffice to drive a complete installation process. In another system management functions such as Tivoli Software Distribution, Computer Associates Unicenter TNG®, Intel LANDesk® Management Suite, and Novell ZENWorks™ for Desktops have been used to provide a means for describing various packages for installation. Unfortunately, these descriptions lack cross-platform consistency, and are dependent on the specific installation tool and/or system management tool being used. In addition, the descriptions are not typically or consistently encapsulated with the install image, leading to problems in delivering bundle descriptions along with the corresponding software bundle, and to problems when it is necessary to update both the bundle and the description in a synchronized way. (The CIM standard is described in “Systems Management: Common Information Model (CIM)”, Open Group Technical Standard, C804 ISBN 1-85912-255-8, August 1998. “Unicenter TNG” is a registered trademark of Computer Associates International, Inc. “LANDesk” is a registered trademark of Intel Corporation. “ZENWorks” is a trademark of Novell, Inc.)

The related inventions teach use of an object model and framework for software installation packages and address many of these problems of the prior art, enabling the installation process to be simplified for software installers as well as for the software developers who must prepare their software for an efficient, trouble-free installation. While the techniques disclosed in the related inventions provide a number of advantages and are functionally sufficient, the present invention describes further efficiencies that may be used to improve the installation process.

### SUMMARY OF THE INVENTION

An object of the present invention is to provide an improved technique for installation of software packages.

It is another object of the present invention to provide this technique using a model and framework that provides for a consistent and efficient installation across a wide variety of target installation environments.

Another object of the present invention is to provide this technique using a model and framework that can be used by software developers to describe all pertinent aspects of an installation package such that automated and/or manual installation processes are simplified and made more efficient.

Still another object of the present invention is to provide a technique for improved software installation by using an incremental conditional installation technique.

Yet another object of the present invention is to provide this technique wherein one or more components of the software installation process may be cached.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for improving installation of software packages. This technique comprises: defining an object model representing a plurality of components of a software installation process, wherein the defined model enables specifying conditional installation information for the components; and populating the object model to describe a particular software installation package, wherein the conditional installation information is populated with information to describe conditional installation scenarios. The technique preferably further comprises using the conditional installation information of the populated object model during an installation of the particular software installation package to determine whether the installation should be performed, and performing the installation if so. The technique preferably also further comprises instantiating a plurality of objects according to the defined object mode, each of the instantiated objects corresponding to a selected one of the components of the software installation process, and wherein the populating is of these instantiated objects. In preferred embodiments, the instantiated objects are JavaBeans. In other embodiments, the instantiated objects may be structured documents or objects in a scripting language.

The conditional installation information may comprise a suite-level conditional installation component, one or more software component-level conditional installation components, or a combination thereof In this case, the technique may further comprise evaluating the suite-level conditional installation component and/or the one or more software component-level conditional installation components as preconditions to installing (or to downloading and installing) a corresponding one of the components of the particular software installation package.

The conditional installation information may comprise an executable code module, or a reference to an executable code module.

In an optional enhancement, the technique further comprises caching one or more of the plurality of instantiated objects. In this case, downloading of the cached ones of the plurality of instantiated objects may be avoided.

The present invention will now be described with reference to the following drawings, in which like reference numbers denote the same element throughout.

### BRIEF DESCRIPTION OF THE DRAWINGS

FIG. 1 is a block diagram of a computer hardware environment in which the present invention may be practiced;

FIG. 2 is a diagram of a networked computing environment in which the present invention may be practiced;

FIG. 3 illustrates an object model that may be used for defining software components to be included in an installation package, according to the related inventions;

FIG. 4 depicts an object model that may be used for defining a suite, or package, of software components to be installed, according to the related inventions;

FIGS. 5 and 6 depict resource bundles that may be used for specifying various types of product and variable information to be used during an installation, according to an embodiment of the related inventions; and

FIGS. 7-10 depict flowcharts illustrating logic with which a software installation package may be processed, according to preferred embodiments of the present invention.

### DESCRIPTION OF PREFERRED EMBODIMENTS

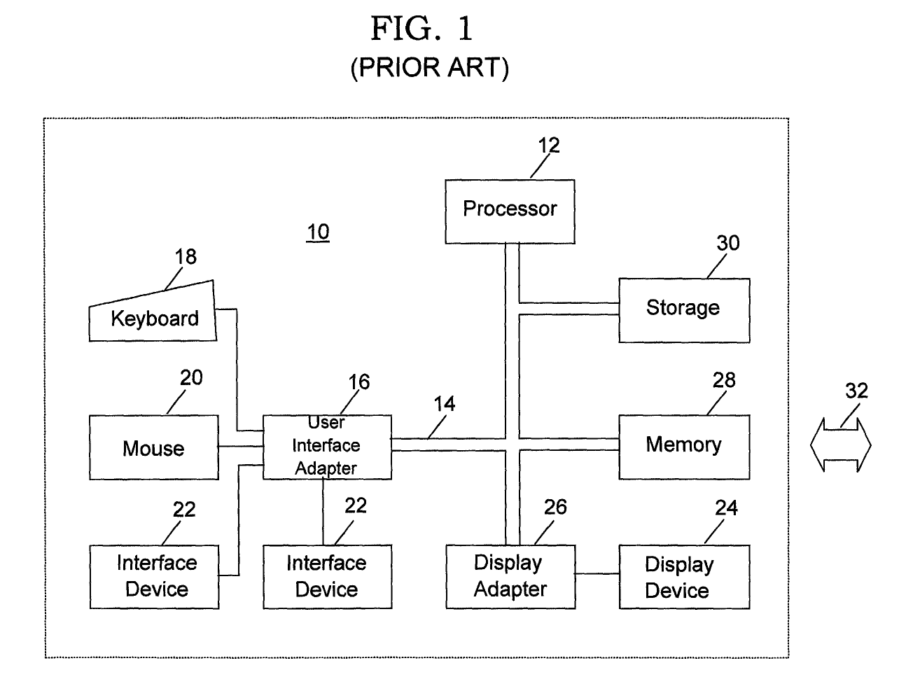

FIG. 1 illustrates a representative computer hardware environment in which the present invention may be practiced. The device 10 illustrated therein may be a personal computer, a laptop computer, a server or mainframe, and so forth. The device 10 includes a microprocessor 12 and a bus 14 employed to connect and enable communication between the microprocessor 12 and the components of the device 10 in accordance with known techniques. The device 10 typically includes a user interface adapter 16, which connects the microprocessor 12 via the bus 14 to one or more interface devices, such as a keyboard 18, mouse 20, and/or other interface devices 22 (such as a touch sensitive screen, digitized entry pad, etc.). The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The device 10 may communicate with other computers or networks of computers, for example via a communications channel or modem 32. Alternatively, the device 10 may communicate using a wireless interface at 32, such as a CDPD (cellular digital packet data) card. The device 10 may be associated with such other computers in a LAN or a wide area network (WAN), or the device 10 can be a client in a client/server arrangement with another computer, etc. All of these configurations, as well as the appropriate communications hardware and software which enable their use, are known in the art.

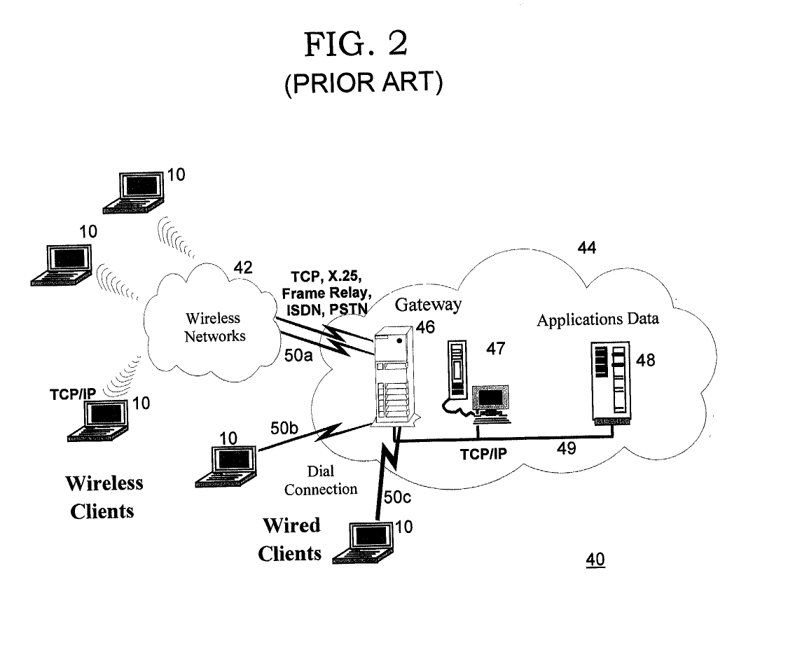

FIG. 2 illustrates a data processing network 40 in which the present invention may be practiced. The data processing network 40 may include a plurality of individual networks, such as wireless network 42 and network 44, each of which may include a plurality of devices 10. Additionally, as those skilled in the art will appreciate, one or more LANs may be included (not shown), where a LAN may comprise a plurality of intelligent workstations or similar devices coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be coupled to another network 42 by means of a communications link 50a. The gateway 46 may also be directly coupled to one or more devices 10 using a communications link 50b, 50c. Further, the gateway 46 may be indirectly coupled to one or more devices 10. The gateway computer 46 may also be coupled 49 to a storage device (such as data repository 48). The gateway computer 46 may be implemented utilizing an Enterprise Systems Architecture/370™ available from the International Business Machines Corporation (IBM), an Enterprise Systems Architecture/390® computer, etc. Depending on the application, a midrange computer, such as an Application System/400® (also known as an AS/400®) may be employed. (“Enterprise Systems Architecture/370” is a trademark of IBM; “Enterprise Systems Architecture/390”, “Application System/400”, and “AS/400” are registered trademarks of IBM.)

Those skilled in the art will appreciate that the gateway computer 46 may be located a great geographic distance from the network 42, and similarly, the devices 10 may be located a substantial distance from the networks 42 and 44. For example, the network 42 may be located in California, while the gateway 46 may be located in Texas, and one or more of the devices 10 may be located in New York. The devices 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or UDP (User Datagram Protocol) over IP, X.25, Frame Relay, ISDN (Integrated Services Digital Network), PSTN (Public Switched Telephone Network), etc. The devices 10 may alternatively connect directly to the gateway 46 using dial connections 50b or 50c. Further, the wireless network 42 and network 44 may connect to one or more other networks (not shown), in an analogous manner to that depicted in FIG. 2.

In preferred embodiments, the present invention is implemented in software. Software programming code which embodies the present invention is typically accessed by the microprocessor 12 (e.g. of device 10 and/or server 47) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

A user of the present invention (e.g. a software installer or a software developer creating a software installation package) may connect his computer to a server using a wireline connection, or a wireless connection. (Alternatively, the present invention may be used in a stand-alone mode without having a network connection.) Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing capabilities (and communication capabilities, when the device is network-connected). The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

When implemented in software, the present invention may be implemented as one or more computer software programs. The software is preferably implemented using an object-oriented programming language, such as the Java™ programming language. The model which is used for describing the aspects of software installation packages is preferably designed using object-oriented modeling techniques of an object-oriented paradigm. In preferred embodiments, the objects which are based on this model, and which are created to describe the installation aspects of a particular installation package, may be specified using a number of approaches, including but not limited to: Javabeans™ or objects having similar characteristics; structured markup language documents (such as Extensible Markup Language, or “XML”, documents); object descriptors of an object modeling notation; or Object REXX or objects in an object scripting language having similar characteristics. (“Java” and “JavaBeans” are trademarks of Sun Microsystems, Inc.)

An implementation of the present invention may be executing in a Web environment, where software installation packages are downloaded using a protocol such as the HyperText Transfer Protocol (HTTP) from a Web server to one or more target computers which are connected through the Internet. Alternatively, an implementation of the present invention may be executing in other non-Web networking environments (using the Internet, a corporate intranet or extranet, or any other network) where software packages are distributed for installation using techniques such as Remote Method Invocation (RMI) or CORBA (Common Object Request Broker Architecture). Configurations for the environment include a client/server network, as well as a multi-tier environment. Or, as stated above, the present invention may be used in a standalone environment, such as by an installer who wishes to install a software package from a locally-available installation media rather than across a network connection. Furthermore, it may happen that the client and server of a particular installation both reside in the same physical device, in which case a network connection is not required. A software developer who prepares a software package for installation using the present invention may use a network-connected workstation, a stand-alone workstation, or any other similar computing device. These environments and configurations are well known in the art.

The target devices with which the present invention may be used advantageously include end-user workstations, mainframes or servers on which software is to be loaded, or any other type of device having computing or processing capabilities (including “smart” appliances in the home, cellular phones, personal digital assistants or “PDAs”, dashboard devices in vehicles, etc.).

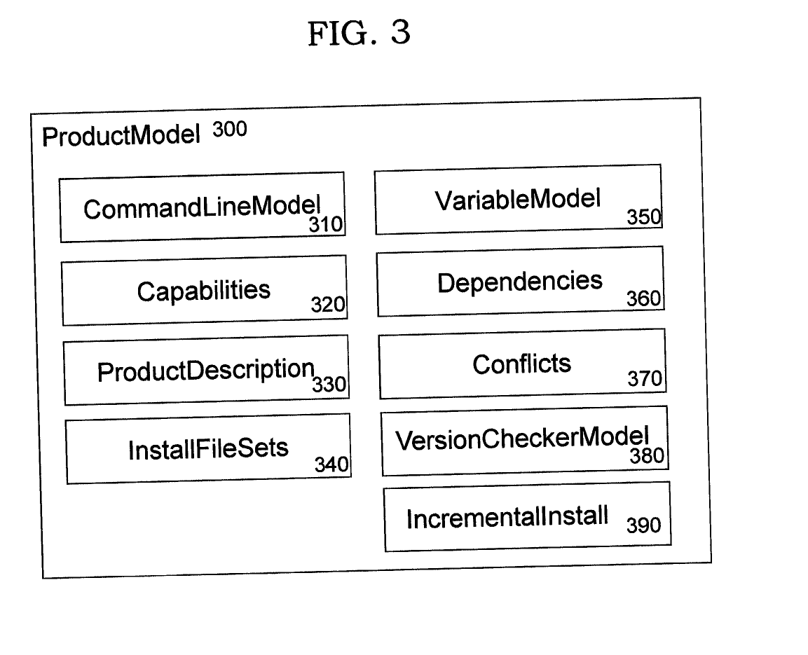

Preferred embodiments of the present invention will now be discussed in more detail with reference to FIGS. 3 through 10.

The present invention uses an object model for software package installation, and discloses an incremental conditional installation process which uses that object model. The object model is used as a framework for creating one or more objects which comprise each software installation package. The present invention also discloses optional caching of selected components. These techniques will be described in more detail herein. Preferred embodiments of the software object model and framework are described in the related inventions. As disclosed therein, each installation object preferably comprises object attributes and methods for the following:

1) A manifest, or list, of the files comprising the software package to be installed.

2) Information on how to access the files comprising the software package. This may involve:

a) explicit encapsulation of the files within the object, or

b) links that direct the installation process to the location of the files (which may optionally include a specification of any required access protocol, and of any compression or unwrapping techniques which must be used to access the files).

3) Default response values to be used as input for automatically responding to queries during customized installs, where the default values are preferably specified in a response file. The response file may specify information such as how the software package is to be subset when it is installed, where on the target computer it is to be installed, and other values to customize the behavior of the installation process.

4) Methods, usable by a systems administrator or other software installation personnel, for setting various response values or for altering various ones of the default response values to tailor a customized install.

5) Validation methods to ensure the correctness and internal consistency of a customization and/or of the response values otherwise provided during an installation. As disclosed in the present invention, validation code may also be included to control an incremental conditional installation process.

6) Optionally, localizable strings (i.e. textual string values that may be translated, if desired, in order to present information to the installer in his preferred natural language).

7) Instructions (referred to herein as the “command line model”) on how the installation program is to be invoked, and preferably, how return code information or other information related to the success or failure of the installation process may be obtained.

8) The capabilities of the software package (e.g. the functions it provides).

9) A specification of the dependencies, including prerequisite or co-requisites, of the software package (such as the required operating system, including a particular level thereof; other software functions that must be present if this package is to be installed; software functions that cannot be present if this package is installed; etc.).

The present invention takes the single install entity described by this installation object model, and utilizes the ability to conditionally run an incremental routine of the single install package before invoking the subsequent dependent routines of the total install package. As an example, in the case of a remote installation, a small prerequisite routine may be dispatched over a network connection from the total install package (rather than sending the entire install package). This dispatched routine may then be executed on the remote machine, and based on its outcome, a return code may be transmitted from the remote machine to indicate whether subsequent routines from the install package should be retrieved and executed.

Using a conditional installation in this manner allows key resources to be conserved during the installation process. In the case of a remote installation, as discussed above, the techniques of the present invention provide the ability to avoid sending a large install program over the network unless it is known that conditions are suitable for subsequently installing the routines contained therein. In the case of a local installation, resources do not need to be allocated for uncompressing an install image and so forth unless criteria for performing the installation are met. This allows for efficient utilization of processor cycles, disk space and resources, as well as the installer's time; and, in scenarios where a network connection is used, this technique also allows for efficient utilization of network bandwidth.

In preferred embodiments, this conditional install approach may be used at a global level for the entire installation suite or package, at a more granular level for individual components of the suite, or a combination thereof, depending on the needs of a particular implementation of the present invention. The criteria and content used for the conditional installation process may vary widely in an implementation-specific manner. As an example, the checking process disclosed herein may comprise executing a relatively small piece of code that determines whether sufficient storage space is available on the client to receive and store an install package. As another example, the checking process may comprise determining whether a user account on the target machine has proper authorization.

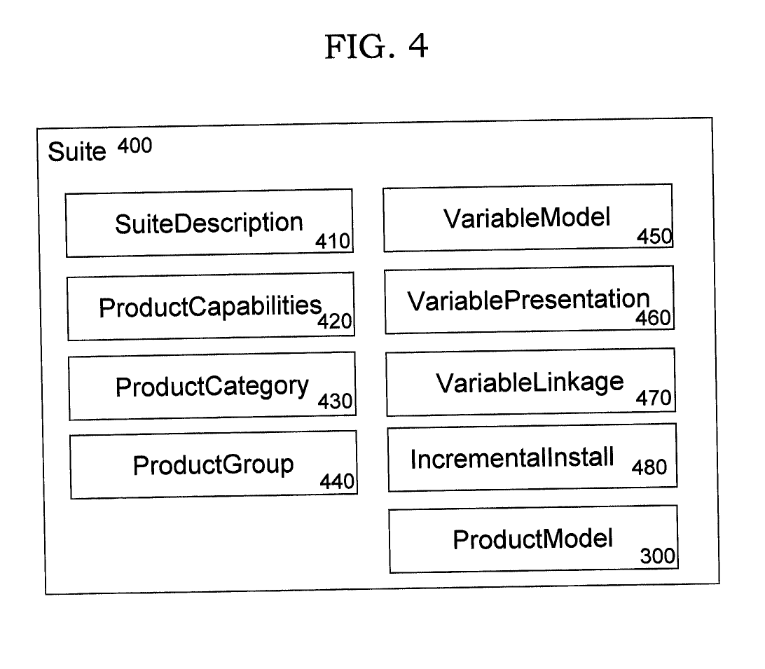

A preferred embodiment of the object model used for defining installation packages as disclosed in the related inventions, and enhancements thereto which may be made for the present invention, is depicted in FIGS. 3 and 4. FIG. 3 illustrates a preferred object model to be used for describing each software component present in an installation package. A graphical containment relationship is illustrated, in which (for example) ProductModel 300 is preferably a parent of one or more instances of CommandLineModel 310, Capabilities 320, etc. FIG. 4 illustrates a preferred object model that may be used for describing a suite comprising all the components present in a particular installation package. (It should be noted, however, that the model depicted in FIGS. 3 and 4 is merely illustrative of one structure that may be used to represent installation packages according to the present invention. Other subclasses may be used alternatively, and the hierarchical relationships among the subclasses may be altered, without deviating from the inventive concepts disclosed herein.) A version of the object model depicted by FIGS. 3 and 4 has been described in detail in the related inventions. This description is presented here as well in order to establish a context for the present invention. Modifications to this object model that may be used for supporting the present invention are also described herein in context of the overall model.

Note that each of the related inventions may differ slightly in the terms used to describe the object model and the manner in which it is processed. For example, the related invention pertaining to use of structured documents refers to elements and subelements, and storing information in document form, whereas the related invention pertaining to use of JavaBeans refers to classes and subclasses, and storing information in resource bundles. As another example, the related inventions disclose several alternative techniques for specifying information for installation objects, including: use of resource bundles when using JavaBeans; use of structured documents encoded in a notation such as the Managed Object Format (“MOF”) or XML; and use of properties sheets. These differences will be well understood by one of skill in the art. For ease of reference when describing the present invention, the discussion herein is aligned with the terminology used in the JavaBeans-based disclosure; it will be obvious to those of skill in the art how this description may be adapted in terms of the other related inventions.

A ProductModel 300 object class is defined, according to the related inventions, which serves as a container for all information relevant to the installation of a particular software component. The contained information is shown generally at 310 through 390, and comprises the information for a particular component installation, as will now be described in more detail.

A CommandLineModel class 310 is used for specifying information about how to invoke an installation (i.e. the “command line” information, which includes the command name and any arguments). In a preferred embodiment of the object model disclosed in the related inventions, CommandLineModel is an abstract class, and has subclasses for particular types of installation environments. These subclasses preferably understand, inter alia, how to install certain installation utilities or tools. For example, if an installation tool “ABC” is to be supported by a particular installation package, an ABCCommandLine subclass may be defined. Instances of this class then provide information specific to the needs of the ABC tool. A variety of installation tools may be supported for each installation package by defining and populating multiple such classes. Preferably, instances of these classes reference a resource or resource bundle which specifies the syntax of the command line invocation. (Alternatively, the information may be stored directly in the instance.)

Instances of the CommandLineModel class 310 preferably also specify the response file information (or a reference thereto), enabling automated access to default response values during the installation process. In addition, these instances preferably specify how to obtain information about the success or failure of an installation process. This information may comprise identification of particular success and/or failure return codes, or the location (e.g. name and path) of a log file where messages are logged during an installation. In the latter case, one or more textual strings or other values which are designed to be written into the log file to signify whether the installation succeeded or failed are preferably specified as well. These string or other values can then be compared to the actual log file contents to determine whether a successful installation has occurred. For example, when an installation package is designed to install a number of software components in succession, it may be necessary to terminate the installation if a failure is encountered for any particular product. The installation engine of the present invention may therefore automatically determine whether each component successfully installed before proceeding to the next component.

Additional information may be specified in instances of CommandLineModel, such as timer-related information to be used for monitoring the installation process. In particular, a timeout value may be deemed useful for determining when the installation process should be considered as having timed out, and should therefore be terminated. One or more timer values may also be specified that will be used to determine such things as when to check log files for success or failure of particular interim steps in the installation.

Instances of a Capabilities class 320 are used to specify the capabilities or functions a software component provides. Capabilities thus defined may be used to help an installer select among components provided in an installation package, and/or may be used to programmatically enforce install-time checking of variable dependencies. As an example of the former, suppose an installation package includes a number of printer driver software modules. The installer may be prompted to choose one of these printer drivers at installation time, where the capabilities can be interrogated to provide meaningful information to display to the installer on a selection panel. As an example of the latter, suppose Product A is being installed, and that Product A requires installation of Function X. The installation package may contain software for Product B and Product C, each of which provides Function X. Capabilities are preferably used to specify the functions required by Product A, and the functions provided by Product B and Product C. The installation engine can then use this information to ensure that either Product B or Product C will be installed along with Product A.

As disclosed in the related inventions, ProductDescription class 330 is preferably designed as a container for various types of product information. Examples of this product information include the software vendor, application name, and software version of the software component. Instances of this class are preferably operating-system specific. The locations of icons, sound and video files, and other media files to be used by the product (during the installation process, and/or at run-time) may be specified in instances of ProductDescription. For licensed software, instances of this class may include licensing information such as the licensing terms and the procedures to be followed for registering the license holder. When an installation package provides support for multiple natural languages, instances of ProductDescription may be used to externalize the translatable product content (that is, the translatable information used during the installation and/or at run-time). This information is preferably stored in a resource bundle (or other type of external file or document, referred to herein as a resource bundle for ease of reference) rather than in an object instance, and will be read from the resource bundle on an on-demand basis.

The InstallFileSets class 340 is used in preferred embodiments of the object model disclosed in the related inventions as a container for information that relates to the media image of a software component. Instances of this class are preferably used to specify the manifest for a particular component. Tens or even hundreds of file names may be included in the manifest for installation of a complex software component. Resource bundles are preferably used, rather than storing the information directly in the object instance.

The related inventions disclose use of the VariableModel class 350 as a container for attributes of variables used by the component being installed. For example, if a user identifier or password must be provided during the installation process, the syntactical requirements of that information (such as a default value, if appropriate; a minimum and maximum length; a specification of invalid characters or character strings; etc.) may be defined for the installation engine using an instance of VariableModel class. In addition, custom or product-specific validation methods may be used to perform more detailed syntactical and semantic checks on values that are supplied (for example, by the installer) during the installation process. As disclosed for an embodiment of the related inventions, this validation support may be provided by defining a CustomValidator abstract class as a subclass of VariableModel, where CustomValidator then has subclasses for particular types of installation variables. Examples of subclasses that may be useful include StringVariableModel, for use with strings; BooleanVariableModel, for use with Boolean input values; PasswordVariableModel, for handling particular password entry requirements; and so forth. Preferably, instances of these classes use a resource bundle that specifies the information (including labels, tooltip information, etc.) to be used on the user interface panel with which the installer will enter the variable information.

Dependencies class 360 is used to specify prerequisites and co-requisites for the installation package, as disclosed in the related inventions. Information specified as instances of this class, along with instances of the Capabilities class 320, is used at install time to ensure that the proper software components or functions are available when the installation completes successfully.

The related inventions disclose providing a Conflicts class 370 as a mechanism to prevent conflicting software components from being installed on a target device. For example, an instance of Conflicts class for Product A may specify that Product Q conflicts with Product A. Thus, if Product A is being installed, the installation engine will determine whether Product Q is installed (or is selected to be installed), and generate an error if so.

VersionCheckerModel class 380 is provided to enable checking whether the versions of software components are proper, as disclosed in the related inventions. For example, a software component to be installed may require a particular version of another component.

An IncrementalInstall class 390 may be provided, according to the present invention, for use in a conditional installation of the corresponding software component. (Alternatively, this information may be represented within one or more of the previously-defined classes.) As stated earlier, conditional installation techniques may vary widely, and therefore the information represented in an instance of IncrementalInstall class may have a number of forms. As one example, an instance may comprise executable code that is written by the install package developer to investigate the client system for one or more criteria and return a success or failure indication. As another example, an instance of IncrementalInstall may comprise a reference to executable code of this type which may, for example, be already stored on the client. Some implementations of the present invention may choose to support only suite-level conditional installation, in which case IncrementalInstall 390 is omitted.

When conditional installation is being performed, according to the present invention, a timer value of the type previously described with reference to CommandLineModel 310 may optionally be used to determine when the installation engine can reasonably assume that an error has occurring during the conditional checking process (to be described below) and that no response will therefore likely be returned. Or, a timer value may be used to determine when to check a log file for success or failure of the conditional checking process.

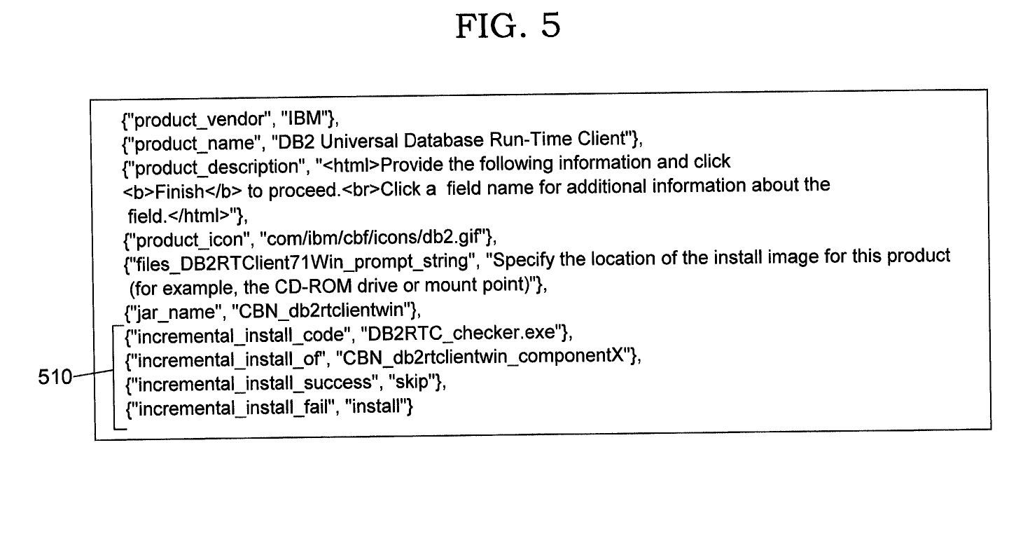

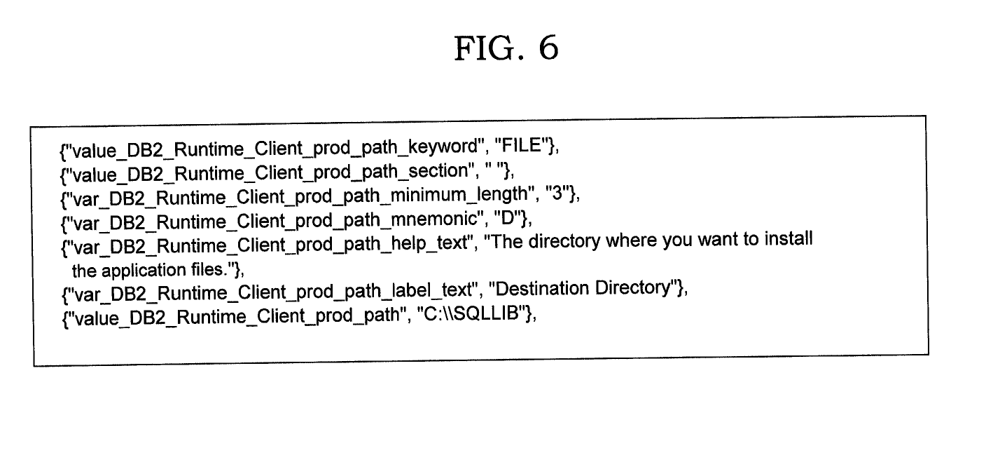

Preferably, the resource bundles referenced by the software components of the present invention are structured as product resource bundles and variable resource bundles. Examples of the information that may be specified in product resource bundles (comprising values to be used by instances of CommandLineModel 310, etc.) and in variable resource bundles (with values to be used by instances of VariableModel 350, ProductDescription 330, etc.) are depicted in FIGS. 5 and 6, respectively. FIG. 5 includes an example of syntax 510 indicating how an incremental install process using a code module named “DB2RTC_checker.exe” that determines whether to install a component named “CBN_db2rtclientwin_componentX” may be represented in a product resource bundle. This example further illustrates explicitly specifying values “skip” and “install” for use when returning a success or failure indication, respectively, resulting from execution of the checking process. (Note that while 2 resource bundles are shown for the preferred embodiment, this is for purposes of illustration only. The information in the bundles may be organized in many different ways, including use of a separate bundle for each class. When information contained in the bundles is to be translated into multiple natural languages, however, it may be preferable to limit the number of such bundles.)

Referring now to FIG. 4, an object model as disclosed in the related inventions for representing an installation suite comprising all the components present in a particular installation package, and enhancements thereto which may be made for the present invention, will now be described. A Suite 400 object class serves as a container of containers, with each instance containing a number of suite-level specifications in subclasses shown generally at 410 through 480. Each suite object also contains one or more instances of ProductModel 300 class, one instance for each software component in the suite. The Suite class may be used to enforce consistency among software components (by handling the inter-component prerequisites and co-requisites), and to enable sharing of configuration variables among components. Furthermore, as disclosed herein, the Suite class 400 may contain suite-level information to be used in a conditional installation, as will be described below.

SuiteDescription class 410 is defined in the related inventions as a descriptive object which may be used as a key when multiple suites are available for installation. Instances of SuiteDescription preferably contain all of the information about a suite that will be made available to the installer. These instances may also provide features to customize the user interface, such as build boards, sound files, and splash screens.

As disclosed in the related inventions, ProductCapabilities class 420 provides similar information as Capabilities class 320, and may be used to indicate required or provided capabilities of the installation suite.

ProductCategory class 430 is defined in the related inventions for organizing software components (e.g. by function, by marketing sector, etc.). Instances of ProductCategory are preferably descriptive, rather than functional, and are used to organize the display of information to an installer in a meaningful way. A component may belong to multiple categories at once (in the same or different installation suites).

As disclosed in the related inventions, instances of ProductGroup class 440 are preferably used to bundle software components together for installation. Like an instance of ProductCategory 430, an instance of ProductGroup groups products; unlike an instance of ProductCategory, it then forces the selection of all software components at installation time when one of the components in the group (or an icon representing the group) is selected. The components in a group are selected when the suite is defined, to ensure their consistency as an installation group.

Instances of VariableModel class 450 provide similar information as VariableModel class 350, as discussed in the related inventions, and may be used to specify attributes of variables which pertain to the installation suite.

VariablePresentation class 460 is used, according to the related inventions, to control the user interface displayed to the installer when configuring or customizing an installation package. One instance of this class is preferably associated with each instance of VariableModel class 450. The rules in the VariableModel instance are used to validate the input responses, and these validated responses are then transmitted to each of the listening instances of VariableLinkage class 470.

As disclosed in the related inventions, instances of VariableLinkage class 470 hold values used by instances of VariableModel class 450, thereby enabling sharing of data values. VariableLinkage instances also preferably know how to translate information from a particular VariableModel such that it meets the requirements of a particular ProductModel 300 instance.

The present invention defines an IncrementalInstall class 480 that may be provided for use in a conditional installation that pertains to the entire suite. (Suite-level conditional installation information may alternatively be represented in one or more of the existing classes.) If an implementation chooses not to support conditional installation at the suite level, then this class 480 is omitted. The suite-level IncrementalInstall class 480 is similar to the component-level IncrementalInstall class 390 which was previously described. As an example of suite-level checking, code may be performed to detect the type of target device and to suppress installation of large installation images in certain cases, based upon that information (e.g. for constrained devices such as PDAs or devices that connect to a network using a relatively expensive wireless connection).

Each instance of ProductModel class 300 in a suite is preferably independently serializable, as discussed in the related inventions, and is merged with other such serialized instances comprising an instance of Suite 400.

During the customization process, an installer may select a number of physical devices or machines on which software is to be installed from a particular installation package. Furthermore, he may select to install individual ones of the software components provided in the package. This is facilitated by defining a high-level object class (not shown in FIGS. 3 or 4) which is referred to herein as “Groups”, which is a container for one or more Group objects. A Group object may contain a number of Machine objects and a number of ProductModel objects (where the ProductModel objects describe the software to be installed on those machines, according to the description of FIGS. 3 and 4). Machine objects preferably contain information for each physical machine on which the software is to be installed, such as the machine's Internet Protocol (IP) address and optionally information (such as text for an icon label) that may be used to identify this machine on a user interface panel when displaying the installation package information to the installer.

When using JavaBeans of the Java programming language to implement installation objects according to the installation object model, the object attributes and methods to be used for installing a software package are preferably specified as properties and methods of the JavaBeans. A JavaBean is preferably created for each software component to be included in a particular software installation package, as well as another JavaBean for the overall installation suite. When using Object REXX, the object attributes and methods to be used for installing a software package are preferably specified as properties and methods in Object REXX. When using structured documents, the object attributes and methods are preferably specified as elements in the structured documents. (Refer to the related inventions for a detailed discussion of these approaches.)

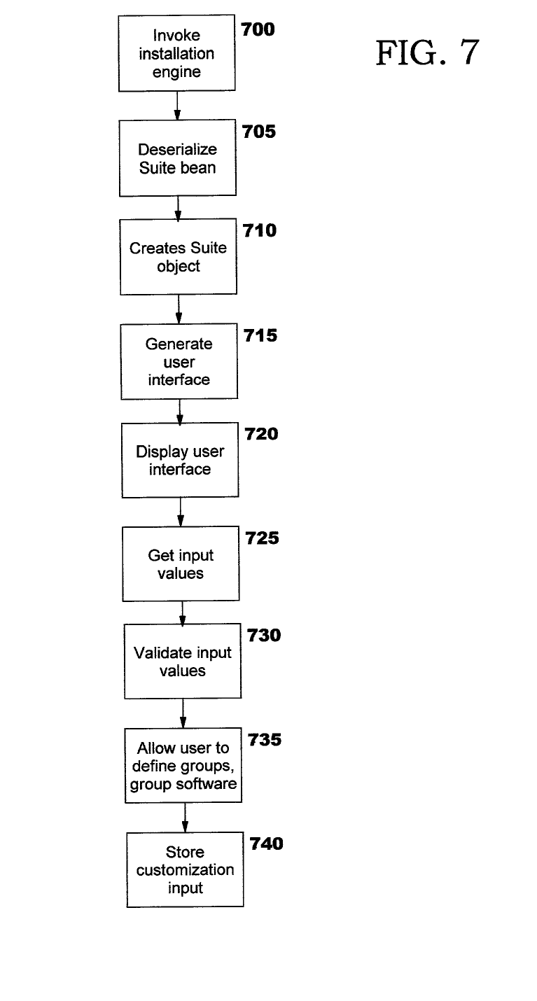

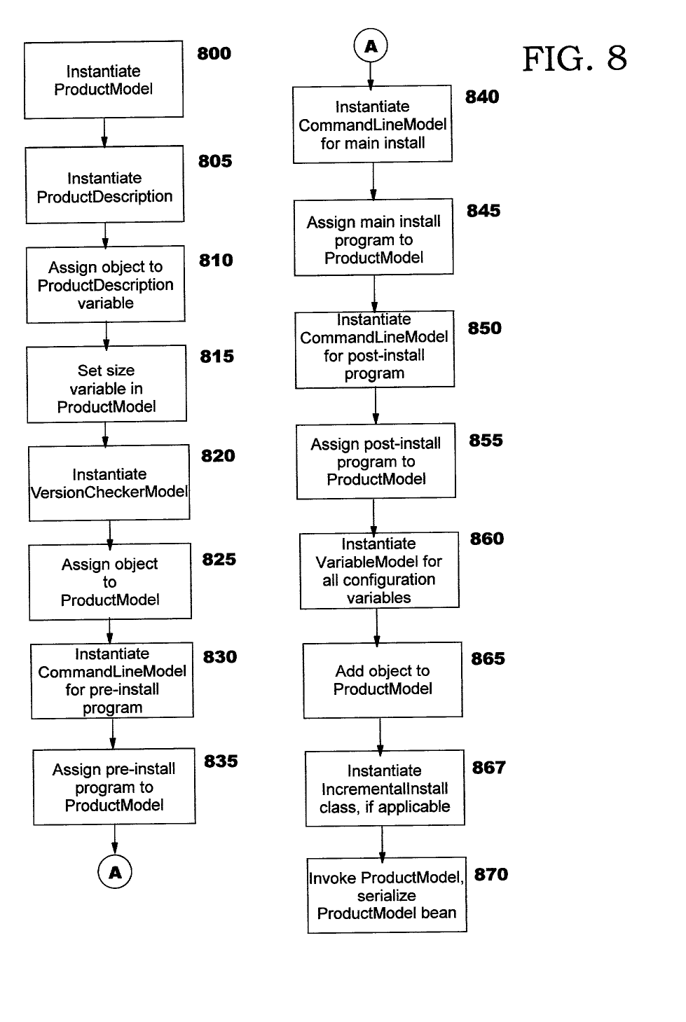

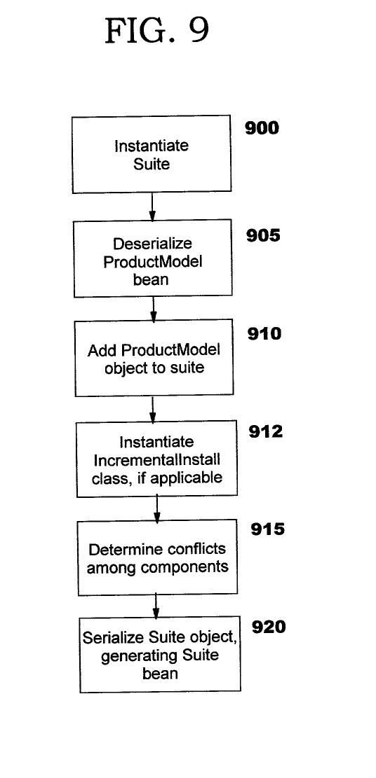

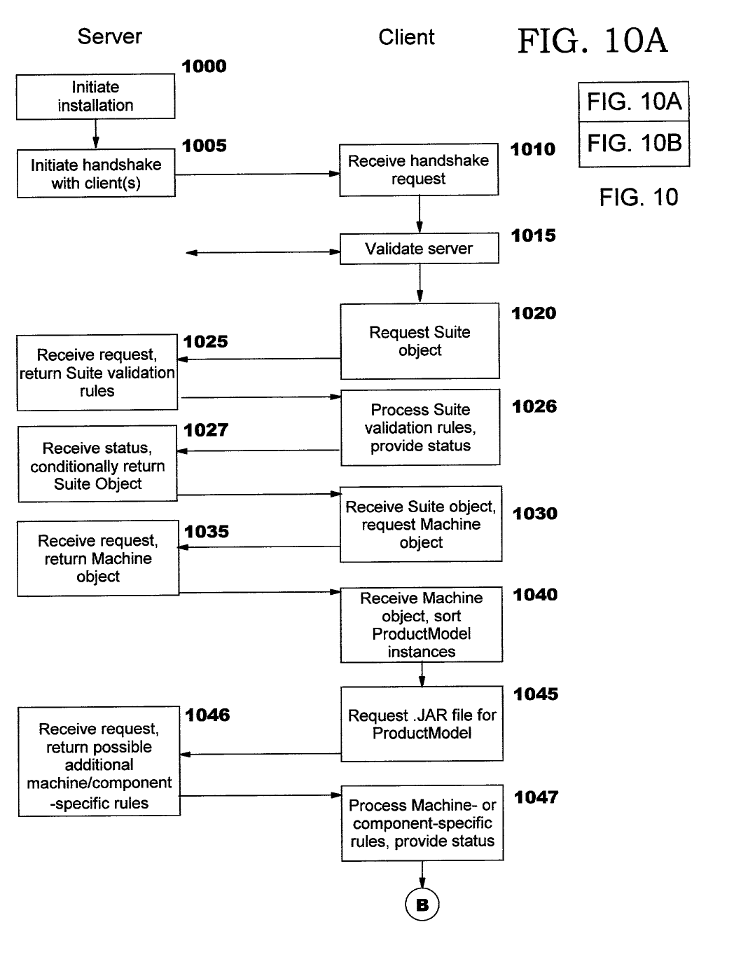

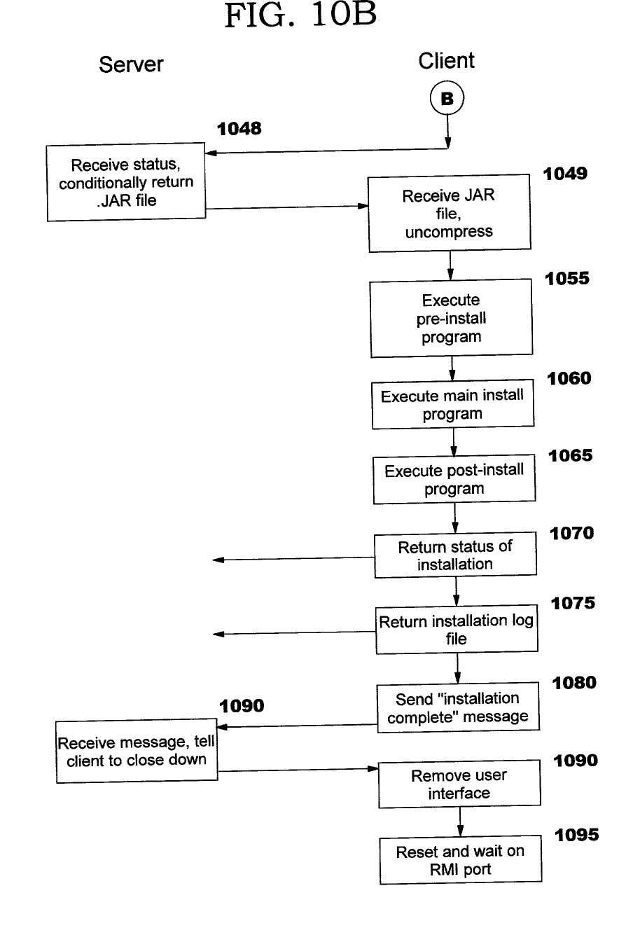

The process of customizing a software installation package for use in a particular target environment, building the component (i.e. ProductModel) objects and Suite object, and then performing the installation using the incremental conditional installation technique of the present invention will now be described with reference to the flowcharts in FIGS. 7 through 10. (These processes may be performed in succession during one invocation of the installation engine of the present invention, or may be separated in time by invoking individual ones of these functions in the installation engine.) It should be noted that the related inventions have disclosed a general software installation process using the model and framework of their respective FIGS. 3 and 4, and preferred embodiments of logic which may be used to implement this installation process have been described therein with reference to their respective FIGS. 7 through 10. The discussion of the logic underlying the installation process in FIGS. 7 through 10 is repeated herein to establish a context for describing the present invention. Alterations to this processing to support the present invention are also described within the overall context of these figures. In preferred embodiments of the present invention, the processing which was described in FIGS. 8, 9, and 10 of the related inventions is altered to improve efficiency of resource utilization during the software installation process. (In particular, see the discussion herein of Block 867 of FIG. 8, Block 912 of FIG. 9, and Blocks 1026, 1027, 1046, 1047, 1048, and 1049 of FIG. 10.)

Furthermore, the optional caching technique which may be used with the present invention is preferably reflected during processing of those operations which refer to downloading information to a target machine: when using caching, this downloading may be avoided if a suitable copy of a selected installation component to be downloaded is available from cache. This caching optimization may be used for one or more selected installation components of an installation package, including: the entire package; conditional checking code used by the present invention; instances of ProductModel 300; etc. The option of retrieving information from cache storage, and then bypassing the downloading operation, is not shown in the figures. It will be obvious to one of skill in the art how the logic which is depicted may be modified to provide this caching optimization once the inventive techniques disclosed herein are known. (Note that there may be cases in which caching is not deemed useful, for example when the installation process will not be repeated for a particular client. Caching is considered optional for use with the present invention.)

A software installer invokes the installation engine (Block 700), and then selects a particular software suite to be customized (Block 705). The corresponding Suite bean is deserialized (Block 710), as required, creating a Suite object (Block 715). Using information previously stored in the Suite object, a user interface is generated (Block 720). One or more ProductModel beans which comprise the Suite bean may also be deserialized at this time, if they are stored independently, and information from the resulting ProductModel objects may be used when generating the user interface. For example, a generated user interface may present a name and descriptive information about the suite (using the SuiteDescription 410 instance), and a name and descriptive information for each component in the suite (using ProductDescription 330 instances).

The generated user interface is then displayed (Block 725) to the installer. Customization values are then accepted from the installer (Block 730). Optionally, the installer may provide information that will subsequently be used during the conditional installation process of the present invention (depending, of course, on what type of information is gathered during the customization process). For example, the installer might identify where a locally-resident checking routine resides, if applicable. At Block 735, this input data is validated using the methods specified in instances of a CustomValidator abstract class. (Refer to the discussion of VariableModel class 350, above, for more information on CustomValidator.) An iterative approach is preferably used for accepting and validating the input data.

When the data entry and validation is complete, control reaches Block 740, where the installer is allowed to define groups of target machines, and to select particular software components from the suite that are to be associated with an installation to that group of machines. This information is then stored in a Group object at Block 745. If the customized suite is not to be built or installed at this time, the object is preferably serialized (not shown in FIG. 7). The Groups object, which is a container for one or more Group objects, is preferably serialized in an initialization file (having the suffix “.ini”). Thus, customization of software and information to be presented on the user interface panel to the installer is preserved in a text file for later use during the installation process.

Note that while FIG. 7 describes customizing an installation package for an entire suite, an installer may also be allowed to individually customize the components of the suite (including providing information that will subsequently be used during component-level conditional checking of the present invention) if the ProductModel 300 instances are independently serialized. Based on the description of FIG. 7, it will be obvious to one of ordinary skill in the art how this logic may be structured.

When the installer is ready to build an installation package reflecting the customized information, he preferably performs a build process on each ProductModel object and then on the Suite object. These processes are illustrated in FIGS. 8 and 9, respectively.

The build process for a ProductModel bean begins at Block 800, where ProductModel 300 is instantiated. At Block 805, ProductDescription is then instantiated, and the resulting object is assigned (Block 810) to a ProductDescription variable of the ProductModel object.

It should be noted that in an object-based embodiment of the present invention, the instantiations described with reference to FIG. 8 are instantiations only of classes, and that internal variables are not being directly set. This is because, in the preferred embodiment, the classes ProductDescription, VersionCheckerModel, CommandLineModel, and VariableModel get their variable information from a resource bundle rather than through variable settings within an object. In a structured document-based embodiment, the discussions of instantiations preferably represent parsing of documents that hold the values of properties or attributes of these elements.

Next, a size variable of ProductModel is set to the installed size of this software component (Block 815). VersionCheckerModel is then instantiated (Block 820), and the resulting object is assigned (Block 825) to ProductModel. Preferably, this assignment comprises issuing a “setVersionChecker (VersionCheckerModel)” call.

Block 830 instantiates CommandLineModel 310, or one of its subclasses for a particular installation environment (as discussed above), and assigns the resulting object to ProductModel at Block 835. This assignment preferably comprises issuing a call having syntax such as “setpreInstall (CommandLineModel)”. In the preferred embodiment, custom programs may be invoked to perform integration of a suite in its target environment, and/or integration of individual ones of the components. The particular custom programs to be invoked are thus defined using instances of CommandLineModel, in the same manner that a CommandLineModel instance defines how to invoke the installation of each particular component. Issuing the “setPreinstall” call establishes the custom program that is to be executed prior to installing this component (and may be omitted when there is no such program). Another instance of CommandLineModel (or a subclass) is then instantiated and assigned to ProductModel to specify invocation information for installation of the component itself (Blocks 840 and 845). The assignment may be performed using call syntax such as “setInstall (CommandLineModel)”. If a custom post-installation integration program is to be executed, Blocks 850 and 855 instantiate the proper object and assign it to ProductModel using a call with syntax such as “setPostInstall (CommandLineModel)”.

For each configuration variable of this component, a subclass of VariableModel is instantiated (Block 860) and added to ProductModel (Block 865). An instance of IncrementalInstall class 390 is instantiated and added to ProductModel (Block 867) if a component-level conditional installation is defined for this component. Finally, an invocation of ProductModel is performed (Block 870), which generates a serialized output ProductModel bean.

The build process for a Suite bean begins at Block 900 of FIG. 9, where Suite 400 is instantiated. For each component in the suite, the ProductModel bean is deserialized (Block 905) and the resulting ProductModel object is added (Block 910) to a vector of suite products. An instance of IncrementalInstall class 480 is instantiated and added to Suite 400 (Block 912) if a suite-level conditional installation is defined for this suite. Block 915 determines whether any of the products in the suite conflict with one another, using the information stored in each Conflicts class 370. Assuming that all conflicts are resolved, Block 920 serializes the Suite object to generate an output Suite bean.

FIG. 10 depicts a preferred embodiment of logic with which the installation time processing, including the conditional installation processing of the present invention, may be performed. This processing is described in terms of installation from a staging server on which the suite beans and component beans are stored (or are otherwise accessible), across a network to one or more target devices. It will obvious to one of ordinary skill in the art how the process of FIG. 10 may be altered for use in other installation scenarios, including installation on a stand-alone machine which is not connected to a network, a local installation where the client and server are co-resident, and installation using a conventional client/server “pull” model rather than the “push” model illustrated in FIG. 10.

The installation process of FIG. 10 begins with an installer initiating the installation process (Block 1000), for example by selecting a suite from a user interface display. The staging server then preferably initiates a handshaking protocol with each target device (Block 1005). The staging server installation scenario of FIG. 10 requires each target machine to have “listener” software installed, where this software is adapted to receiving installation notifications from the staging server. At Block 1010, the listener software on a client (target) device receives the handshaking request. An authentication process is then preferably performed (Block 1015), to ensure that software is being downloaded from a trusted source. In the preferred embodiment, this authentication process comprises sending a challenge to the staging server, which the staging server will then sign using the private key of a previously-created public/private key pair. When this signed challenge is received by the client device, the client validates the signature using the staging server's public key. (Techniques for performing authentication using signed messages in this manner are well known in the art, and will not be described further herein.)

If the authentication is successful, the client then requests delivery of a suite object, where the suite object will contain one or more component objects for installation on this client device (Block 1020). The staging server receives this request (Block 1025). In the related inventions, the staging server returns the appropriate Suite object at this point. However, it may happen that the client lacks required resources or is otherwise unable or unwilling to perform a particular suite installation process. The present invention therefore defines an optimization whereby a checking process is performed before transmitting the entire Suite object to the client. (A Suite object may in some cases be quite large, and therefore will require fairly significant resources for transmitting and receiving the object.) This conditional installation technique also proves advantageous where a local installation process is performed (i.e. where the client and server reside in the same machine or are otherwise able to avoid requiring network transmission of the Suite object). For example, the client in this latter scenario may avoid wasted resource utilization such as devoting significant storage resources for uncompressing files of a Suite object, populating temporary directories for use in the installation process, and so forth, all of which would be fruitless if the installation process cannot go forward. Therefore, in preferred embodiments the present invention returns one or more suite validation rules or components to the target client at this point. These validation rules or components preferably comprise implementation-specific executable code of some form, and the client processes those rules (Block 1026) in an implementation-specific manner. (Note that references to “rules” are not intended to imply limitation of the conditional checking process to use with rule-based systems, although this is one manner in which the conditional checking may be carried out.) As an example of the code that may be transmitted at Block 1025, and the processing thereof in Block 1026, the server may transmit a program that conveys the size of the suite's install image, and which checks to see if the client has room to store (and perhaps to unpackage) this image. As another example, a program might be transmitted that checks to see if a required port is open. More complex examples may be envisaged as well and may be similarly accommodated using the techniques of the present invention.

Status information is preferably provided to the server in Block 1026 after the checking process executes, which may occur by passing a success or failure return code or perhaps by logging information into a file which the server is adapted to searching in order to find this information. Assuming the server receives a positive status (Block 1027), it then returns the Suite object to the client. (When the status is negative, a message indicating that the installation is not being performed may be generated, and the processing of FIG. 10 then ends.)

In alternative embodiments, code to perform the conditional checking process may already be resident on the client. In this case, the processing of Block 1025 may include sending a message to the client to trigger execution of this code. Or, the client may have previously executed the checking code in some cases, and the processing of Block 1026 may then comprise making the status of that checking process available to the server (if it is not already available).

Upon receiving the Suite object, the client may then request (Block 1030) delivery of a Machine object. A Machine object contains one or more component objects which are appropriate to this particular type of client device, as previously described. After receiving this request, the staging server returns the requested object (Block 1035).

When the requested object is received, the client preferably sorts the component objects according to a priority value that may be specified in ProductModel, and/or dependencies on other components (Block 1040). Block 1045 then begins an iterative process that extends through Block 1075, and which is performed for each component that is to be installed. At Block 1045, the client sends a request to the staging server for the jar (Java Archive) file for this component. The server receives this request (Block 1046), and may optionally return additional machine-specific or component-specific rules or code to the client. The client processes these rules or code (Block 1047), in a similar manner to that described above for Block 1026 and then provides status information to the server. Upon receiving or otherwise obtaining the status information (Block 1048), the server returns the component's jar file to the client if the status is positive. If the status is negative, then this iteration of the component installation logic of Blocks 1045 through 1075 ends, and control returns to Block 1045 to begin processing the next component. (Note that a negative result of the checking process is not considered to be an error condition, but merely indicates that installation of this component is to be bypassed.) As an example of using a component-level conditional installation, the IBM WebSphere® product requires presence of a directory, a database, and a Web server, but any Web server (such as a Domino™ server, Apache server, etc.) will suffice. (“WebSphere” is a registered trademark of IBM, and “Domino” is a trademark of Lotus Development Corporation.) Rather than forcing each target client to accept downloading of a (possibly redundant) Web server, the component-level conditional installation process of the present invention may be used to first determine whether a Web server is already present on the client and to suppress the downloading (and installation) thereof if so.

Upon receiving the jar file, the client preferably uncompresses it (Block 1049) and then executes the pre-install program (Block 1055), if one has been defined. Block 1060 then executes the installation of the component itself, and Block 1070 executes the post-install program, if one has been defined for this component. (Refer to the description of Blocks 830 through 855, above, for more information on pre- and post-install programs.)

The status of the component installation is returned to the staging server (Block 1070). If a log file was defined for this purpose, as previously described, the log file is also returned (Block 1075).

When all components have been installed (or a decision has been made according to the present invention that selected components are not to be installed), control reaches Block 1080. The client preferably sends a “Suite installation complete” message to the staging server. Optionally, this message may contain a summary (or list or other identification) of the components which were newly installed; or, conversely, it may include a summary of the components for which installation was not performed, according to the conditional installation process of the present invention. Upon receiving this message, the staging server issues a message to the client (Block 1085), telling it to close down the installation process. The client, upon receiving this message, performs termination logic such as removing the installation user interface (Block 1090). The client then resets and waits on its RMI port (Block 1095). (In the preferred embodiment, HTTP message exchanges are used for transferring relatively large amounts of data; RMI is used for lightweight message exchange.) The installation processing then ends.

As has been demonstrated, the present invention defines an improved installation process using an object model and framework that provides a standard, consistent approach to software installation across many variable factors such as product and vendor boundaries, computing environment platforms, and the language of the underlying code as well as the preferred natural language of the installer. Use of the conditional installation process (and, optionally, the caching process) of the present invention will enable the installation process to operate more efficiently by conserving resource utilization.

The concept of running multiple separate programs that would bootstrap and conditionally invoke an installation program is not new and has been implemented by various practitioners of the art. However, no techniques are known in the art which provide conditional installation using a single install package as described herein. Instead, all prior art techniques known to the inventors use separate programs, as contrasted to using a single install package which has been packaged to include the conditional installation logic (or a reference thereto) according to an install model. A brief review of several prior art techniques will now be presented.

Commonly-assigned U.S. Pat. No. 5,473,772 to Halliwell et al., which is titled “Automatic Update of Static and Dynamic Files at a Remote Network Node in Response to Calls Issued By Or For Application Programs”, deals with software updating where decisions whether or not to install a particular package depend on whether the update package is newer or older than the target package. While this is a staged process, the decision being made is not whether to continue an installation process but whether to use an update package or stay with a previously-installed package. U.S. Pat. No. 5,721,824 to Taylor, which is titled “Multiple-Package Installation with Package Dependencies”, suggests that software components (packages) be split into dominant and secondary packages and that the order in which the packages are installed should be dependent upon constraints of the target system. Apparently only the order of installation is changed based upon this determination. The installation is not staged as a conditional installation which continues only if an initial or earlier stage has a positive outcome.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of improving installation of software packages, comprising steps of:
defining an object model representing a plurality of components of a software installation process, wherein the defined model enables specifying conditional installation information for the components; and
populating the object model to describe a particular software installation package, wherein the conditional installation information is populated with information to describe conditional installation scenarios.

2. The method according to claim 1, further comprising steps of:
using the conditional installation information of the populated object model during an installation of the particular software installation package to determine whether the installation should be performed; and
performing the installation if so.

3. The method according to claim 1, further comprising the step of instantiating a plurality of objects according to the defined object mode, each of the instantiated objects corresponding to a selected one of the components of the software installation process, and wherein the populating step populates the instantiated objects.

4. The method according to claim 3, wherein the instantiated objects are JavaBeans.

5. The method according to claim 1, wherein the conditional installation information comprises a suite-level conditional installation component.

6. The method according to claim 1, wherein the conditional installation information comprises one or more software component-level conditional installation components.

7. The method according to claim 1, wherein the conditional installation information comprises a suite-level conditional installation component and one or more software component-level conditional installation components.

8. The method according to claim 7, further comprising the step of evaluating the suite-level conditional installation component and/or the one or more software component-level conditional installation components as preconditions to installing a corresponding one of the components of the particular software installation package.

9. The method according to claim 7, further comprising the step of evaluating the suite-level conditional installation component and/or the one or more software component-level conditional installation components as preconditions to downloading and installing a corresponding one of the components of the particular software installation package.

10. The method according to claim 1, wherein the conditional installation information comprises an executable code module.

11. The method according to claim 1, wherein the conditional installation information comprises a reference to an executable code module.

12. The method according to claim 3, further comprising the step of caching one or more of the plurality of instantiated objects.

13. The method according to claim 12, wherein the caching step further comprises the step of avoiding downloading of the cached ones of the plurality of instantiated objects.

14. A system for improving installation of software packages, comprising:
means for defining an object model representing a plurality of components of a software installation process, wherein the defined model enables specifying conditional installation information for the components; and
means for populating the object model to describe a particular software installation package, wherein the conditional installation information is populated with information to describe conditional installation scenarios.

15. The system according to claim 14, further comprising:
means for using the conditional installation information of the populated object model during an installation of the particular software installation package to determine whether the installation should be performed; and
means for performing the installation if so.

16. The system according to claim 14, further comprising means for instantiating a plurality of objects according to the defined object mode, each of the instantiated objects corresponding to a selected one of the components of the software installation process, and wherein the means for populating populates the instantiated objects.

17. The system according to claim 16, wherein the instantiated objects are objects in a scripting language.

18. The system according to claim 1, wherein the conditional installation information comprises a suite-level conditional installation component and one or more software component-level conditional installation components.

19. The system according to claim 18, further comprising means for evaluating the suite-level conditional installation component and/or the one or more software component-level conditional installation components as preconditions to downloading and installing a corresponding one of the components of the particular software installation package.

20. The system according to claim 14, wherein the conditional installation information comprises an executable code module.

21. The system according to claim 14, wherein the conditional installation information comprises a reference to an executable code module.

22. The system according to claim 16, further comprising means for caching one or more of the plurality of instantiated objects.

23. The system according to claim 22, wherein the means for caching further comprises means for avoiding downloading of the cached ones of the plurality of instantiated objects.

24. A computer program product for improving installation of software packages, the computer program product embodied on one or more computer-readable media and comprising:
computer-readable program code means for defining an object model representing a plurality of components of a software installation process, wherein the defined model enables specifying conditional installation information for the components; and
computer-readable program code means for populating the object model to describe a particular software installation package, wherein the conditional installation information is populated with information to describe conditional installation scenarios.

25. The computer program product according to claim 24, further comprising:
computer-readable program code means for using the conditional installation information of the populated object model during an installation of the particular software installation package to determine whether the installation should be performed; and
computer-readable program code means for performing the installation if so.

26. The computer program product according to claim 25, further comprising computer-readable program code means for instantiating a plurality of objects according to the defined object mode, each of the instantiated objects corresponding to a selected one of the components of the software installation process, and wherein the computer-readable program code means for populating populates the instantiated objects.

27. The computer program product according to claim 26, wherein the instantiated objects are structured documents

28. The computer program product according to claim 24, wherein the conditional installation information comprises a suite-level conditional installation component and one or more software component-level conditional installation components.

29. The computer program product according to claim 28, further comprising computer-readable program code means for evaluating the suite-level conditional installation component and/or the one or more software component-level conditional installation components as preconditions to installing a corresponding one of the components of the particular software installation package.

30. The computer program product according to claim 29, further comprising computer-readable program code means for evaluating the suite-level conditional installation component and/or the one or more software component-level conditional installation components as preconditions to installing a corresponding one of the components of the particular software installation package.

31. The computer program product according to claim 24, wherein the conditional installation information comprises an executable code module.

32. The computer program product according to claim 26, further comprising computer-readable program code means for caching one or more of the plurality of components.

33. The computer program product according to claim 32, wherein the computer-readable program code means for caching further comprises computer-readable program code means for avoiding downloading of the cached ones of the plurality of components.
